(19) United States
(12) Patent Application Publication
(10) Pub. No.: US 2006/0032383 A1
(43) Pub. Date: Feb. 16, 2006

(54) Raised tray with moulded canal

(76) Inventor: John Madonia, Concord (CA)

Correspondence Address: GIFFORD, KRASS, GROH, SPRINKLE & CITKOWSKI, P.C, PO BOX 7021, TROY, MI, 48007-7021, US

(21) Appl. No.: 11/031,652

(22) Filed: Jan. 5, 2005

(30) Foreign Application Priority Data
Aug. 11, 2004 (CA) 2479988

(51) Int. Cl. A23G 1/10

(52) U.S. Cl. 99/485

(57) ABSTRACT

The present invention is a horizontal base for stabilizing vertically extending walls comprising a tray surface elevated from said base, the tray surface defining at least one moulded canal of a pre-defined shape, the at least one moulded canal being defined to receive at least one of said vertically extending walls. The base is preferably used in arts and crafts endeavours and in particular, for improved efficiency in the construction of gingerbread-based structures such as gingerbread houses.

### RELATED APPLICATION

This application claims priority of Canadian Patent Application Serial No. 2,479,988 filed Aug. 11, 2004, which is incorporated herein by reference.

### FIELD OF THE INVENTION

The present invention relates to raised trays having moulded canals, and more specifically to said trays used in the manufacture of arts and crafts, especially gingerbread houses.

### BACKGROUND OF THE INVENTION

The construction of various arts and crafts objects often require the assembling and adhesion of two or more vertical walls together. This type of construction is frequently seen in the assembling of gingerbread houses—a confectionary-based craft immensely popular with children worldwide, particularly during holiday seasons.

A large variety of gingerbread house models are known, such as Chuang (US Pat. Nos. D465,314S and D453,123S), Brown (U.S. Pat. No. D314,854S) and Chiu (U.S. Pat. No. D378,286S). However, one-person assembly of such gingerbread houses (and other gingerbread-based structures) is typically difficult and cumbersome, especially at the starting stage. Although children are typically the largest target audience of the gingerbread-based industry, most children require adult assistance in the actual assembly of gingerbread-based structures having more than one vertical wall. Even adults often require a second set of hands to properly build a gingerbread house in a time-efficient manner.

The standard mode of construction of gingerbread-based structures (having more than one vertical wall) typically first requires that the consumer acquire a flat surface upon which to work. The flat surface may be a countertop, but is more typically a flat cardboard slate having a food-grade foil-wrap. Other types of flat surfaces (made of various materials) can be used, and may be provided within a pre-fabricated gingerbread house kit to the consumer. The flat surface, apart from preferably being safe for food handling, usually presents no other significant advantages.

The consumer places two pieces of gingerbread onto the flat surface, and bonds them together typically using an adhesive confectionary icing already known in the industry. Eventually, in the standard gingerbread house construction, the consumer attempts to add a third and fourth vertical wall, and attempts to bond them to the previously bonded walls. The vertical walls must also, almost simultaneously, be bonded to the flat working surface (for portability, stability, cosmetics and display in different locations).

This preliminary assembly step is problematic for at least two reasons: first, the flat surface does not provide any guidelines as to the orientation of one vertical wall to another or in relation to the flat surface, and so the consumer is left to guess whether the angles formed by one wall bonding to another are sufficient in order to produce a stable gingerbread house, or the position of a wall in relation to the surface is sufficient in terms of allocated space; and second, when the consumer attempts to bond and stabilize all four walls together, the walls typically shift in position (due to uneven pressure applied by the consumer's hands), and this results in a warped-shaped or otherwise unstable and cosmetically unappealing gingerbread house.

These difficulties cannot normally be overcome unless the consumer recruits a second individual to assist in holding and stabilizing some of the vertical walls, and additionally requires the consumer to pre-plan the placement of all walls of the proposed structure. These difficulties are also present in other gingerbread-based structures, for example, gingerbread-based railroad cars/trains. One-man construction of gingerbread houses is typically time-consuming and generally not an enjoyable experience to all but the most patient.

### SUMMARY OF THE INVENTION

In a preferred embodiment the present invention provides a horizontal base for stabilizing vertically extending walls. The base is comprised of a tray surface elevated from the base. The tray surface defines at least one moulded canal of a pre-defined shape, and the at least one moulded canal is defined to receive at least one vertically extending wall.

### DESCRIPTION OF THE DRAWINGS

FIG. 1 is a perspective view of a raised tray with a moulded canal.

FIG. 2 is a perspective view of a raised tray and vertically extending walls being prepared for assembly to the tray.

FIG. 3 is a perspective view of a raised tray and one vertically extending wall being assembled to the tray.

FIG. 4 is a perspective view of a raised tray and two vertically extending walls being assembled to each other and the tray.

FIG. 5 is a perspective view of a gingerbread house construction near completion in the tray.

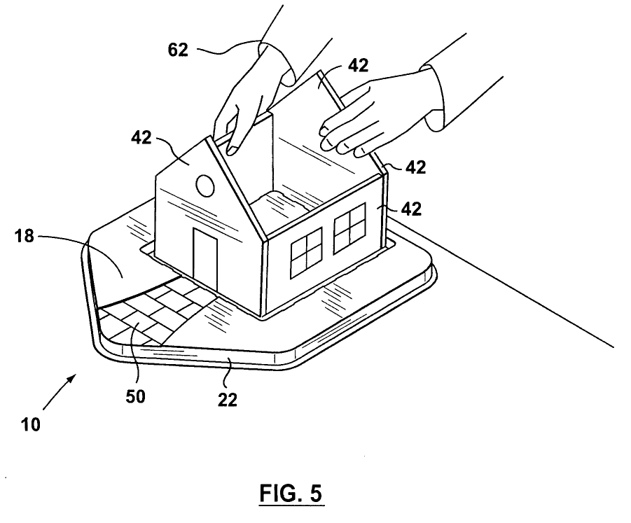

### DETAILED DESCRIPTION OF THE DRAWINGS

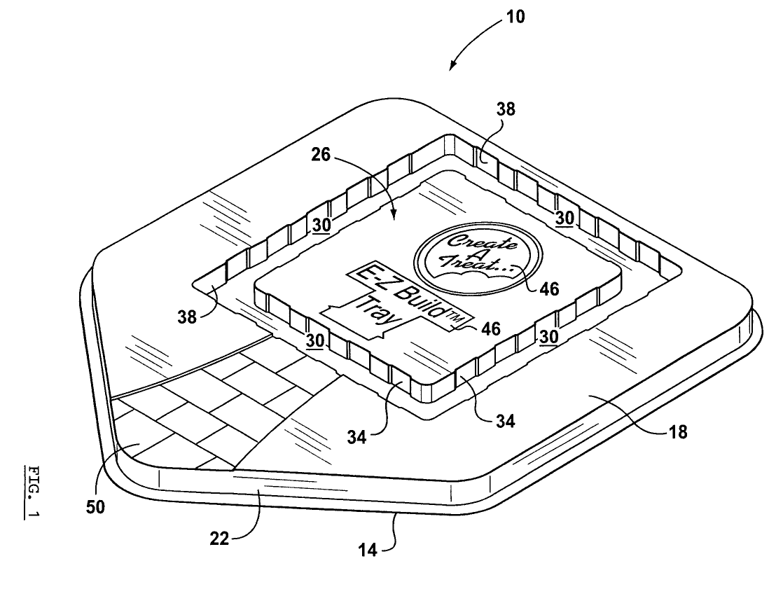

FIG. 1, reference numeral 10 refers generally to a preferred embodiment of the present invention. In particular, FIG. 1 shows a horizontal base 14 having an elevated tray surface 18 extending vertically from said base 14, defining a vertical outer wall perimeter 22. The vertical wall perimeter 22 gives the entire tray 10 stability, although it is possible (but not preferable) to omit the vertical wall perimeter 22.

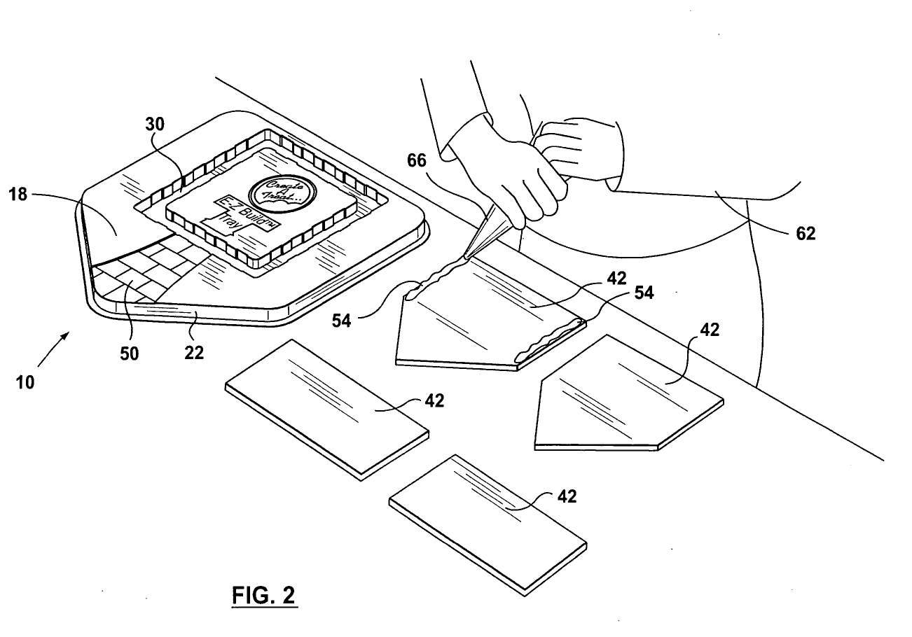

A central portion 26 of the tray surface 18 defines a moulded canal 30. The canal 30 is inscribed by an inner 34 and outer 38 canal perimeter wall. The canal 30 and perimeter walls 34, 38 define a channel to receive at least one vertically extending wall 42 (see FIG. 2). The canal 30 may optionally define a single separate arbitrary start and stop point (not shown), or may be continuous by enclosing in on itself to form one continuous channel (FIG. 1).

When the tray surface 18 defines a plurality of canals 30, the canals 30 may be placed within close proximity to each other, to facilitate the erection of any particular structure having spaced vertical walls 42. In another optional configuration, the canals 30 may define pinched ends (not shown) to clearly indicate a start and stop point of the canal 30, with the pinched ends defining small openings or gaps (not shown) to openly communicate with other adjacent canals 30. Yet another optional configuration is to define some canals 30 as being in close proximity with other canals 30, but not in open communication with said canals 30, while other canals 30 are defined to be in open communication with still other canals 30. The placement, shape, number and positioning of the canal(s) 30 can be readily varied as required by any particular project, and in endless combination and variation.

The canals 30 may be of differing width (although most projects will typically require an identical width), and are of a pre-defined shape and size so as to matingly receive a vertical wall 42. An adhesive 54 (such as quick-setting icing in the case of a gingerbread house) can be optionally applied to the canal 30 to increase the stability of a vertical wall 42 mated to the canal 30.

The entire tray 10 itself, or portions thereof, can be made from a variety of materials depending on the needs of the project. In the instance of a gingerbread house kit, it is preferable to make the entire tray 10 of a food grade material, and in particular, with respect to the parts of the tray that will contact the gingerbread (namely the canals 30 and perimeter walls 34, 38) from a food-grade plastic. Polyethylene terephthalate (popularly known as PET plastic within the industry) is an excellent choice in particular for the construction of the tray 10 (or the parts specified above), and such plastic tray 10 can be manufactured using any standard industrial method such as vacuum forming, injection moulding, or others.

The remainder of the tray surface 18 can be used to indicate a manufacturer's trade-mark 46, or other cosmetic variations as the project requires. For example, in the instance of a gingerbread house, the tray surface 18 can be texturized to simulate a walkway 50 to the gingerbread house. In the instance of a gingerbread train or railway cars (not shown), the texturized surface can simulate train tracks or adjuncts of a train station (not shown). Still other portions of the tray surface 18 can define smaller individual canals 30 to receive smaller vertical walls 42 for additional cosmetics (such as a snowman in the instance of a gingerbread house winter scene).

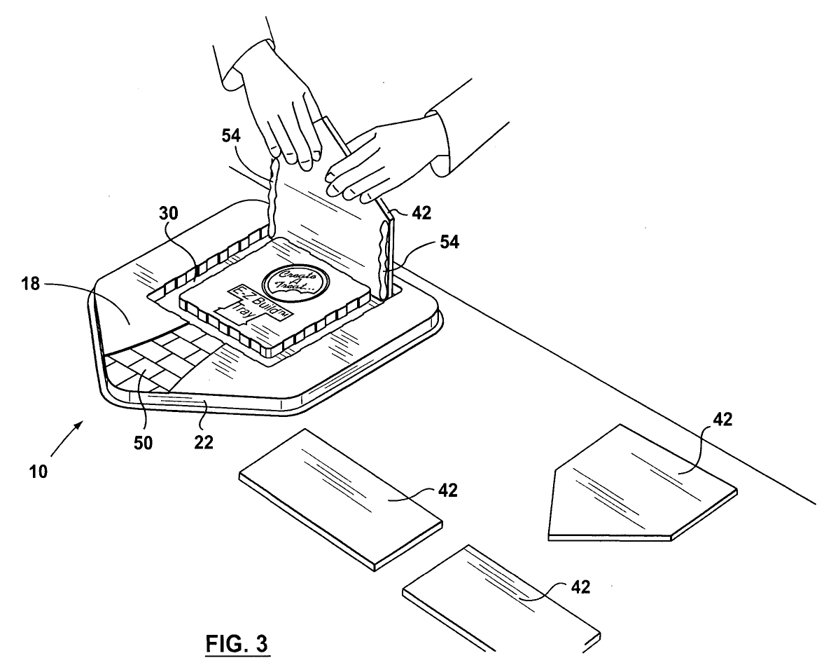

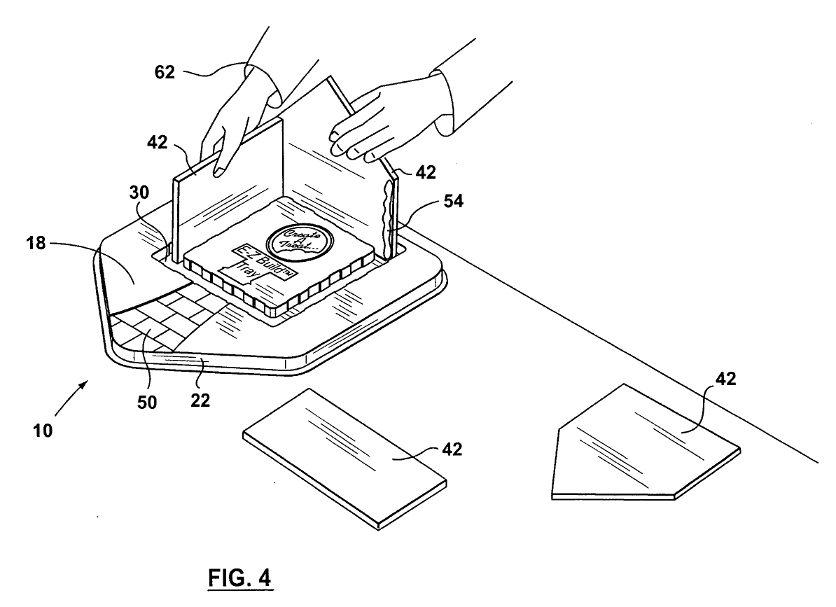

In use, a consumer 62 first preferably prepares or obtains a standard adhesive 54 such as confectionary quick-setting icing, and stores said adhesive into a suitable dispenser 66. The adhesive 54 is dispensed along the required perimeters 58 of the vertically extending walls 42 (if the project so requires), and optionally along the canal 30 (see FIG. 2). The vertically extending walls 42 are then placed into the canal 30 at their required positions (see FIG. 3), and pressed against each other (if the project so requires) to bond the walls 42 to each other (see FIG. 4), and downwardly to bond the walls 42 to the canal 30 (by either a snug friction fit and/or by the adhesive). More walls 42 (if required) are similarly added, and the process is continued to completion of the project.

It is readily understood to one skilled in the art that the present tray 10 is not limited to use for gingerbread-based or quadrilateral-shaped creations, and in particular to gingerbread houses.

1. A horizontal base for stabilizing vertically extending walls comprising a tray surface elevated from said base, the tray surface defining at least one moulded canal of a pre-defined shape, the at least one moulded canal being defined to receive at least one of said vertically extending walls.

2. The horizontal base as defined in claim 1 wherein the tray defines more than one moulded canal, each of said moulded canals being of a pre-defined shape, each of said moulded canals being defined to receive at least one of said vertically extending walls.

3. The horizontal base as defined in claim 2 wherein each of said canals is disposed in close proximity to another of said moulded canals.

4. The horizontal base as defined in claim 2 wherein any of said moulded canals is continuous and in open communication with any other of said moulded canals.

5. The horizontal base as defined in claim 2 wherein each of said moulded canals is continuous and in open communication with another of said moulded canals.

6. The horizontal base as defined in claim 2 wherein each of said moulded canals is continuous and in open communication with another of said moulded canals, so as to form one continuous canal.

7. The horizontal base as defined in claim 2 wherein the number of moulded canals is four.

8. The horizontal base as defined in claim 2 wherein the moulded canals are oriented to form a square shape.

9. The horizontal base as defined in claim 2 wherein the moulded canals are oriented to form a quadrilateral.

10. The horizontal base as defined in claim 1 wherein the base is made of a food-grade material.

11. The horizontal base as defined in claim 1 wherein the tray surface is made of a food-grade material.

12. The horizontal base as defined in claim 1 wherein the base is made of a food-grade plastic.

13. The horizontal base as defined in claim 1 wherein the tray surface is made of a food-grade plastic.

14. The horizontal base as defined in claim 1 wherein the base is made of a material suitable for use in the construction of a gingerbread-based structure.

15. The horizontal base as defined in claim 1 wherein the tray surface is made of a material suitable for use in the construction of a gingerbread-based structure.

16. The horizontal base as defined in claim 1 wherein the base is made of polyethylene terephthalate.

17. The horizontal base as defined in claim 1 wherein the base is made of polyethylene terephthalate.

18. A gingerbread structure building kit containing pre-fabricated pieces of gingerbread vertically extending walls and a horizontal base for stabilizing said walls, the horizontal base comprising a tray surface elevated from said base, the tray surface defining at least one moulded canal of a pre-defined shape, the at least one moulded canal being defined to receive at least one of said vertically extending walls.
